(19) United States
(12) Patent Application Publication
(10) Pub. No.: US 2009/0031260 A1
(43) Pub. Date: Jan. 29, 2009

(54) Method, Computer Program and System Providing for Semiconductor Processes Optimization

(76) Inventors: Matthew Angyal, Stormville, NY (US); Alina Deutsch, Chappaqua, NY (US); Ibrahim M. Elfadel, Cortlandt Manor, NY (US); Raminderpal Singh, Cortlandt Manor, NY (US); Theodorus E. Standaert, Pine Bush, NY (US); Wayne H. Woods, Burlington, VT (US)

Correspondence Address: Harrington & Smith, PC, 4 Research Drive, Shelton, CT, 06484-6212, US

(21) Appl. No.: 11/782,747

(22) Filed: Jul. 25, 2007

(51) Int. Cl. G06F 17/50

(52) U.S. Cl. 716/2

(57) ABSTRACT

A method, computer program and system for the optimization of semiconductor process parameters given a pre-specified set of targets and constraints on electrical performance metrics are disclosed. Semiconductor process engineers who are not expert in the art of electrical analysis or mathematical optimization can readily use the method of this invention in optimizing semiconductor process parameters. Accommodates the differences in design styles, metal layer routing, and electrical metrics using priority schedules that are easy to input and understand. Enables the exploration of the process parameter space using primitive process tolerances and accurate electrical information provided by field solvers and circuit analysis programs.

### FIELD OF THE INVENTION

The present invention relates to semiconductor processes and more particularly to the selection and optimization of process parameters to achieve a pre-specified set of electrical performance criteria for integrated circuits. Specifically, this invention relates to a fully automated method and system for the selection and optimization of said semiconductor process parameters. The automated system includes a graphical user interface to enable those not versed in the arts of electrical engineering or mathematical optimization to acquire semiconductor process parameter targets satisfying the constraints imposed on the electrical performance criteria.

### BACKGROUND

Semiconductor process engineers are generally well versed in the chemical, surface, mechanical, and material sciences. On the other hand, the immediate users of the semiconductor technology, the integrated-circuit designers, formulate their technology requirements in terms of electrical performance metrics, such as signal timings, noise margins, and DC currents.

These performance metrics are derived from primary electrical quantities such as charge mobility, sheet resistance, per-unit-length capacitance, and per-unit-length inductance. These quantities and similar ones are well-known to the electrical engineer but not the process engineer. Very often circuit designers and electrical engineers assume that the semiconductor process parameters (such as device pitches, metal and via thicknesses, dielectric constants, and number of metal levels) are given and cannot be changed. They are then left with only a few geometric parameters to change so as to optimize the electrical performance metrics.

Such geometric parameters include transistor widths, wire widths, and wire spacings. The geometric parameters are sometime referred to as “horizontal” because they only involve quantities used in circuit layout.

The complexity and cost involved in developing new semiconductor processes have become so high that it is no longer affordable to ignore the electrical metrics at the process definition stage. Furthermore, there is a pressing need to use these metrics so as to guide material selection and quantify the amounts and tolerances required for each process step. From the viewpoint of the integrated-circuit designer, there is also the pressing need that the electrical design space be enlarged so as to include, not just the “horizontal” parameters but also some of the “vertical” parameters of the semiconductor process. The latter can be done by the process engineer at the process definition stage and not by the circuit designer at the circuit design stage.

It remains though that the path from process data to electrical data is very intricate and requires expert knowledge not available to process engineers. Furthermore, the semiconductor process itself is becoming very involved in advanced technologies, which further complicates the evaluation of electrical metrics.

See, B. Mbouombouo and S. Sabada, Optimized Metal Stack Strategy, U.S. Pat. No. 6,587,991B1, issued: July 1^{st}, 2003. Within the area where the semiconductor process deals with the interconnect structures connecting the active devices of an electrical circuit, this reference teaches a method for optimizing some of the process parameters of the interconnect metal stack based on critical path information. The system described uses “interconnect data of timing critical paths from at least one previous design to generate interconnect statistical [process] data.” A problem with such system is that it is design-style dependent as it is well known that the critical paths of a high-performance microprocessor are quite different from the timing critical paths of, for example, a digital signal processing (DSP) integrated circuit. Furthermore, the signal timings metrics along critical paths, while very important, are not sufficient for having a well-rounded view of integrated circuit behavior and cost.

Consider M. B. Anand et. al., “Multiobjective Optimization of VLSI Interconnect Parameters”, IEEE Transactions on Computer-Aided Design of Integrated Circuits and Systems, Vol. 17, No. 12, 1998, pp. 1252-1261. and M. B. Anand et. al., “Optimization Study of VLSI Interconnect Parameters”, IEEE Transactions on Electron Devices, Vol. 47, No. 12, 2000, pp. 178-186. The systems and methods of these references avoid tying the optimization system and method to a specific design style. However, the approach remains based on a hypothetical critical path in which the interconnect lengths are synthesized using semi-empirical formula's based on Rent's rule (Lanzerotti et. al., “Microminiture packaging and integrated circuitry: The work of E. F. Rent, with an application to on-chip interconnection requirements”, IBM J. of Res. & Dev., Vol. 49, No. 4/5, 2005, pp. 777-803.).

In fact, Lanzerotti et al. indicates that these formulas might have in excess of 50% error with respect to interconnect lengths measured on actual designs, such as macros in a central processing unit of a microprocessor. Furthermore, these systems and methods ignore important metrics, such as noise margins and DC currents.

It is to be noted that the discussed systems and methods are geared toward the circuit designer who is versed in the complex computer-aided design tools that are needed to extract timing critical paths, wire-length and layout information.

What is needed in the art is a way to enable integration of the process design variables ith the performance design variables so that experts in one or the other field can optimize the overall circuit and chip designs across both fields.

### SUMMARY

An exemplary embodiment in accordance with this invention is a method for providing for semiconductor processes optimization (as well as back end of the line (BEOL) Metal stack optimization). The method includes receiving a plurality of electrical metrics, corresponding target values, and corresponding weight factors, for each layer of a semiconductor and receiving semiconductor process parameters, wherein at least one of the process parameters is specified as a statistical distribution. At least one semiconductor process parameter is determined that meets the plurality of electrical metrics within the corresponding target values according to their weight factors. An output provides the at least one determined semiconductor process parameter.

Additionally, a graphical user interface (GUI) is generated to facilitate the receiving of the process parameters, the electrical metrics, the target values, and the weight factors.

Furthermore, the method may include steps involving calculating a new set of electrical metrics from the semiconductor process parameters and sensitivity information with respect to variations in the semiconductor process parameters. This calculated sensitivity information is used to guide the selection of the next set of process parameters. Field solvers may be used for calculating the electrical quantities and their sensitivities.

Additionally, a figure of merit may be used to evaluate the optimality of the process parameters.

Furthermore, the determination of process parameters may be determined by at least one of: an exhaustive search of the process parameter space and a mathematical optimization algorithm. The exhaustive search procedure may be performed in parallel on a cluster of sequential machines. In such a case, the exhaustive search procedure may be controlled using a GUI. Such a GUI may include input fields for the number of sequential machines, the number of simulations per machine and the report interval on each machine.

An additional exemplary embodiment in accordance with this invention is a signal bearing medium tangibly embodying a program of machine-readable instructions executable by a digital processing apparatus to perform operations for providing for semiconductor processes optimization. The program includes operations for receiving a plurality of electrical metrics, corresponding target values, and corresponding weight factors, for each layer of a semiconductor and receiving semiconductor process parameters, wherein at least one of the process parameters is specified as a statistical distribution. At least one semiconductor process parameter is determined that meets the plurality of electrical metrics within the corresponding target values according to their weight factors. An output operation provides the determined semiconductor process parameter(s).

Furthermore, a GUI is generated to facilitate the receiving of the process parameters, the electrical metrics, the target values, and the weight factors.

Additionally, the program may include operations involving calculating a new set of electrical metrics from the semiconductor process parameters and sensitivity information with respect to variations in the semiconductor process parameters. This calculated sensitivity information is used to guide the selection of the next set of process parameters. Field solvers may be used for calculating the electrical quantities and their sensitivities.

Furthermore, a figure of merit may be used to evaluate the optimality of the process parameters.

Additionally, the determination of process parameters may be determined by at least one of: an exhaustive search of the process parameter space and a mathematical optimization algorithm. The exhaustive search procedure may be performed in parallel on a cluster of sequential machines. In such a case, the exhaustive search procedure may be controlled using a GUI. Such a GUI may include input fields for the number of sequential machines, the number of simulations per machine and the report interval on each machine.

A further exemplary embodiment in accordance with this invention is a system for providing for semiconductor processes optimization. The system includes devices for receiving a plurality of electrical metrics, corresponding target values, and corresponding weight factors, for each layer of a semiconductor and receiving semiconductor process parameters, wherein at least one of the process parameters is specified as a statistical distribution. A device generates a (GUI) to facilitate the receiving of the process parameters, the electrical metrics, the target values, and the weight factors. At least one semiconductor process parameter is determined that meets the plurality of electrical metrics within the corresponding target values according to their weight factors. An output device provides the at least one determined semiconductor process parameter.

Additionally, the system may include devices for calculating a new set of electrical metrics from the semiconductor process parameters and sensitivity information with respect to variations in the semiconductor process parameters. This calculated sensitivity information is used to guide the selection of the next set of process parameters.

Furthermore, the determination of process parameters may be determined by an exhaustive search of the process parameter space. The exhaustive search procedure may be performed in parallel on a cluster of sequential machines. In such a case, the exhaustive search procedure may be controlled using a GUI. Such a GUI may include input fields for the number of sequential machines, the number of simulations per machine and the report interval on each machine.

### BRIEF DESCRIPTION OF THE DRAWINGS

The foregoing and other aspects of embodiments of this invention are made more evident in the following Detailed Description, when read in conjunction with the attached Drawing Figures, where:

FIG. 1 shows a Dual damascene interconnect process;

FIG. 2 shows a flowchart illustrating Graphic user interface for the semiconductor process parameters of a dual damascene process;

FIG. 3 shows a spreadsheet showing different electrical metrics;

FIG. 4 shows spreadsheet showing different electrical metric targets as requested by integrated circuit designers;

FIG. 5 shows the user interface to the semiconductor process information;

FIG. 6 shows a Process optimization panel;

FIG. 7 shows a graphical user interface to the electrical metrics used in the semiconductor parameter optimization process;

FIG. 8 shows the user interface to the targets of electrical metrics;

FIG. 9 shows a simplified flowchart of the optimization process;

FIG. 10 shows a view of the geometric structure that the program generates;

FIG. 11 shows an example of output results for single metal layer optimization;

FIG. 12 shows an example of a web output; and

FIG. 13 shows the Graphical user interface for parallel processing.

### DETAILED DESCRIPTION

Exemplary embodiments in accordance with this invention teach a system and method for the optimization of semiconductor process parameters given a pre-specified set of targets and constraints on electrical performance metrics. Users who are not expert in the art of electrical analysis or mathematical optimization can readily use an exemplary embodiment in accordance with this invention to optimize semiconductor process parameters.

One aspect of an exemplary embodiment in accordance with this invention is that it can accommodate the differences in design styles, metal layer routing, and electrical metrics using priority schedules that are easy to input and understand.

Another aspect of an exemplary embodiment is that it can enable the exploration of the process parameter space using primitive process tolerances and accurate electrical information provided by field solvers and circuit analysis programs. A further exemplary embodiment has a graphical user interface adapted to the language used by semiconductor process engineers and a parallel processing feature that significantly speeds up the exploration of the process parameter space.

An exemplary embodiment provides a “backward” optimization. With such a “backward” optimization a user can derive the process parameters that best meet a pre-specified set of electrical metrics.

Further exemplary embodiments in accordance with this invention offer at least the following improvements on the previous systems and methods:

adopts a layer-by-layer approach to the optimization of the semiconductor process unlike the critical-path methods that aggregate all interconnect layers in a single timing path;

enables a variety of metrics, including noise and reliability metrics;

augments signal timing metrics with signal integrity, reliability, and wireability metrics;

allows the setting of “prioritization” schedules among the electrical metrics to accommodate a verity of design styles, such as in microprocessor or application-specific integrated circuit (ASIC) designs; and

uses a graphical user interface addressed to the semiconductor process engineer that gives the user full access to the most accurate calculations and optimizations, while hiding their complexity. This differs from the prior art systems, which are geared toward circuit designers and electrical engineers and so impedes the process engineer's entry into the realm of electrical analysis and optimization.

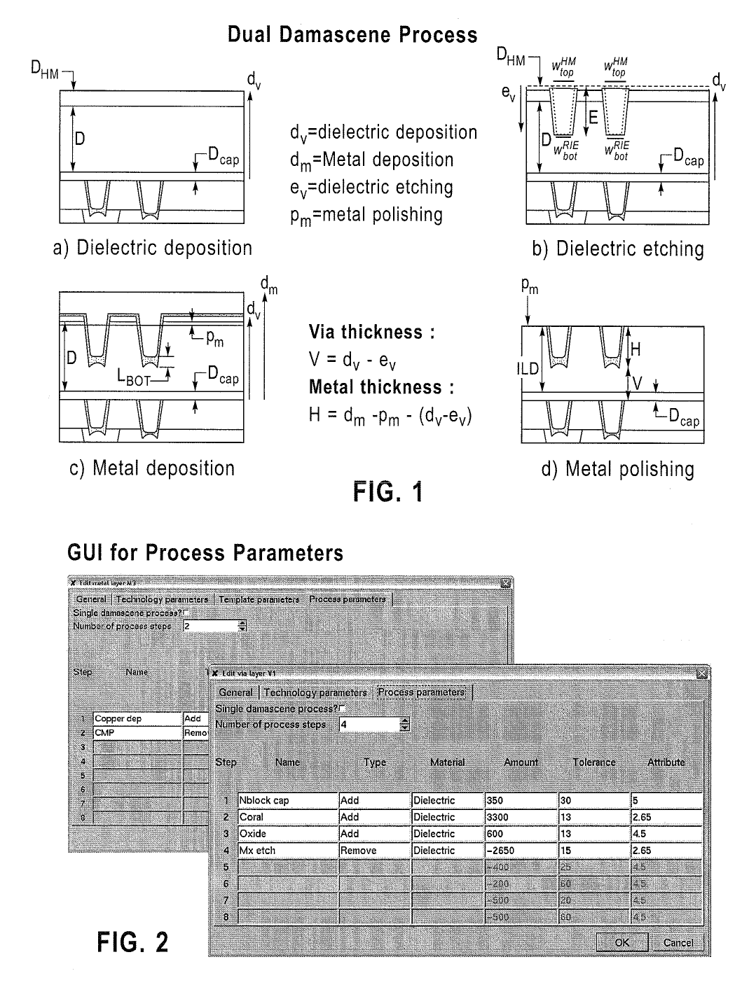

FIG. 1 describes a dual damascene process known in semiconductor fabrication. This process is made of four steps: dielectric deposition (a), dielectric etching (b), metal deposition (c), and metal chemical-mechanical polishing (CMP) (d). FIG. 1 also shows the mathematical relationships between the primitive process variables describing the above process steps and the composite geometric variables used in electrical performance analysis. In particular, one of the relationships connects the via height (V) with the height of the dielectric deposition and the depth of the dielectric etching. Another relationship relates the metal height to the height of metal deposition, depth of metal polishing and height of the via below the metal layer in question. Similar relationships exist for all the composite geometric variables in all the layers.

Exemplary embodiments in accordance with this invention offer major improvements to semiconductor process optimization through the use of the process parameters as primitive parameters. Previously only composite geometric parameters were used.

In an exemplary embodiment of this invention, all of the semiconductor process parameters are revealed to the process engineer in a graphical user interface (GUI). FIG. 2 shows such a GUI where all the process steps of via layer V1 in a semiconductor chip metal stack are revealed. Each step has a name, a type, a material, an amount, a tolerance and an attribute.

The name refers to the step name in the process. It can be the industrial name of the material used in the step or any other name.

The type designates whether the step is an addition of material (deposition) or a subtraction of material (etching or polishing).

The material can be either a dielectric (coral, oxide, etc.) or a metal (copper, aluminum, etc.).

The amount is the quantity of material, added or subtracted, expressed in height or depth of addition or subtraction, respectively.

The tolerance is the 3-sigma uncertainty on the amount of material expressed as percentage of the nominal value entered in the “amount” field.

The attribute is a physical property of the material such as the dielectric constant of the dielectric or the resistivity of the metal.

The process engineer is free to edit and save the values entered in these fields of the GUI. This invention therefore enables the process engineer to pose “what if” questions to the computer system embodying this invention. These “what if” questions can be based on the process parameters the semiconductor process engineer is familiar with rather than the composite geometric parameters familiar to circuit designers. These “what if” processes can be fully automated using targets for electrical metrics and mathematical optimization techniques.

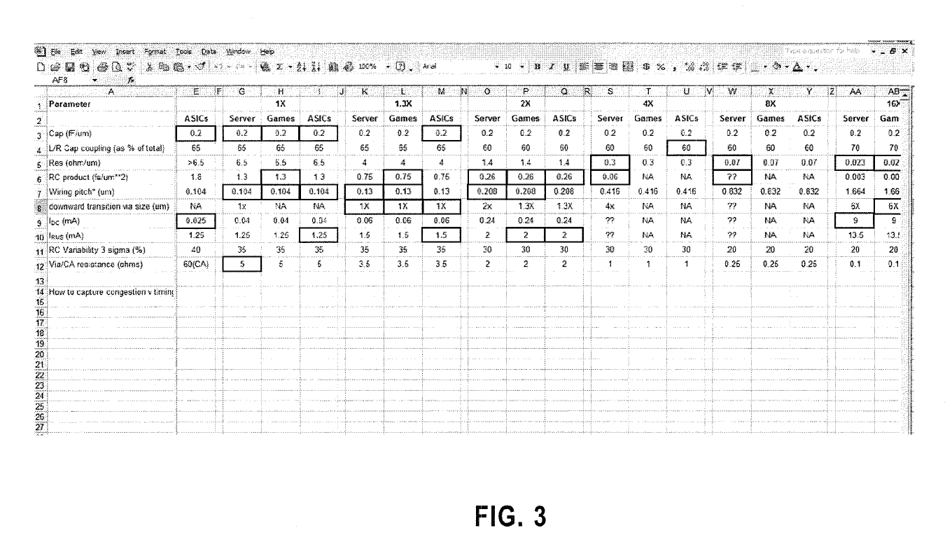

An exhaustive multiplicity of electrical metrics can be accommodated in the optimization method. FIG. 3 is a table illustrating some of these electrical metrics as provided by different groups of integrated circuit designers representing different design styles (ASIC chips, server chips, games chips). It is to be noted that these metrics include not only timing metrics, such as the RC delay, but also reliability metrics such as DC current and RMS current as well as signal integrity metrics such as lateral over total capacitance ratio.

While different design groups may agree on the set of important electrical metrics, the emphasis put on each may vary from one group to another. Furthermore it may vary from one metal layer to another (1×, 1.3×, 2×, 4×, 8×, 16×). Note the cells in shaded boxes in FIG. 3, which indicate different parameter values for different layers of the same end device.

The difference in emphasis from one design style to another and from one metal layer to another in a given design style makes previous optimization processes unsuitable for the current situation. In particular, systems and methods based on timing critical path extraction are not able to reflect the shift in emphasis. Exemplary embodiments in accordance with this invention introduce priority schedules to reflect the importance to be assigned to electrical metrics across design styles and across semiconductor process layers within the same design style.

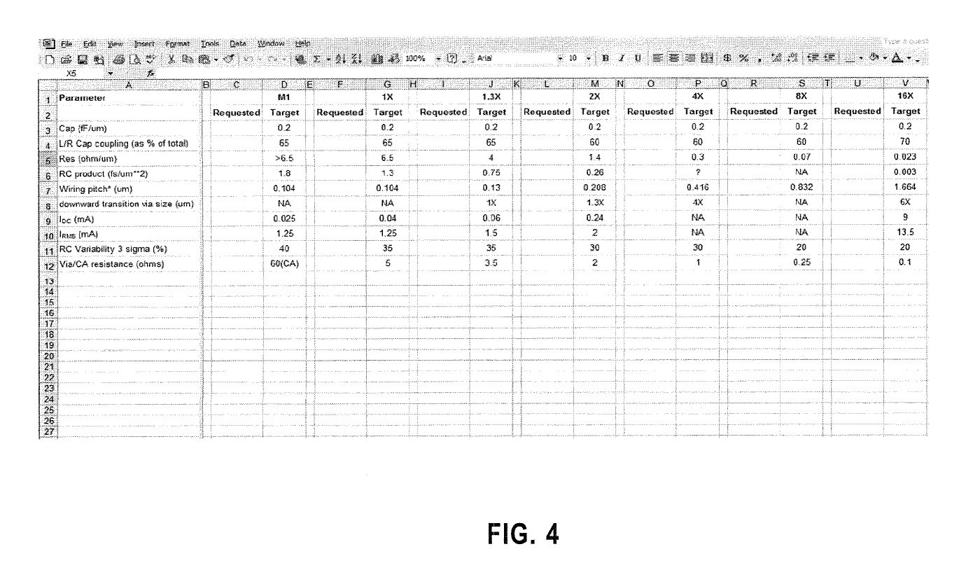

In an exemplary embodiment in accordance with this invention, targets of electrical metrics are assigned to the semiconductor process engineer. FIG. 4 is a table showing values of hypothetical targets for the metrics of FIG. 3. Note that for the same metric, the target varies from one layer to another. This embodiment, unlike the prior art, adopts a layer-by-layer approach to semiconductor process optimization.

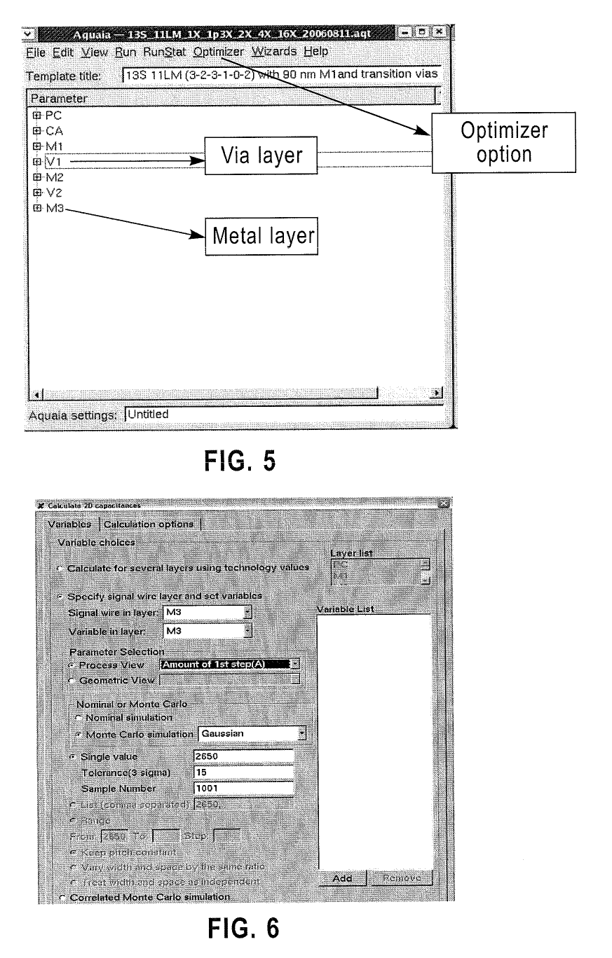

In a further exemplary embodiment in accordance with this invention, the process engineer is presented with a GUI that can be used to enter technology data related to the layer stack as well as optimization parameters. FIG. 5 shows one panel of such interface. In this panel, the technology data of a metal stack is shown having four metal layers (PC, M1, M2, M3) and three via layers (CA, V1, V2). The menu bar at the top of the panel shows the “optimize” option that triggers the display of other user-interface panels related to optimization data. These latter panels in turn trigger the optimization process.

FIG. 6 is one such an optimization panel. The process engineer can specify the metal layer for which the optimization is requested as well as the process parameters pertaining to that layer for which optimal values are to be found. In the example of FIG. 3, the user has specified layer M3 as the layer under optimization. The user has also specified one process variable: the amount of the first step in metal layer M3, which is a metal deposition. The range of variation of each process parameter is specified by a 3-sigma, or other level of precision, tolerance that can be either part of the technology data or part of the input to this optimization panel. Advantageously, none of the parameters entered by the process engineer requires any specialized knowledge or skill outside the generalized field of semiconductor manufacturing.

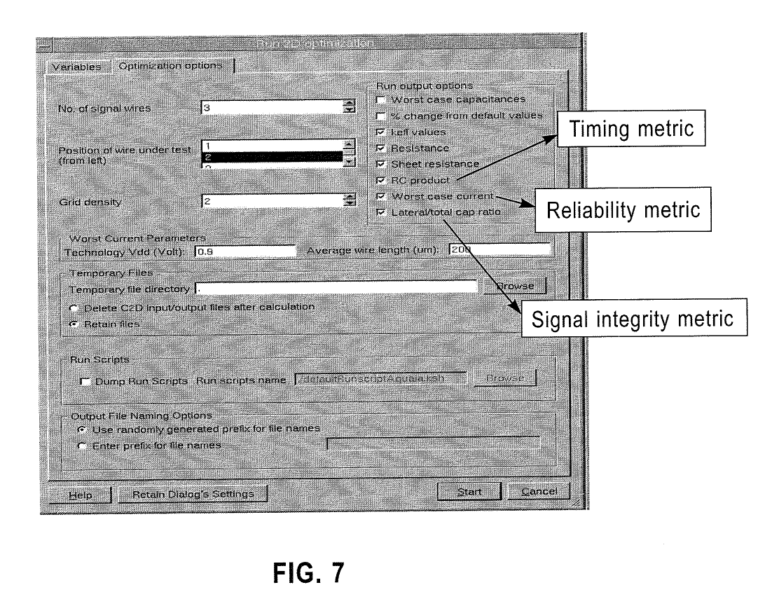

Once layer information is entered, another panel is presented to the user in which electrical metrics and electrical analysis information are requested. This is illustrated in FIG. 7 in which, as an example, the user has chosen six electrical metrics: effective dielectric (keff), resistance, sheet resistance, RC product, worst-case current, and lateral over total capacitance ratio.

For calculating the worst-case current, the user also enters the supply voltage of the technology under consideration as well as the length of the interconnect. The fundamental geometric configuration in this example is that of a centered wire structure that comprises three parallel wires, the middle of which (number 2 in the panel) is the wire under test.

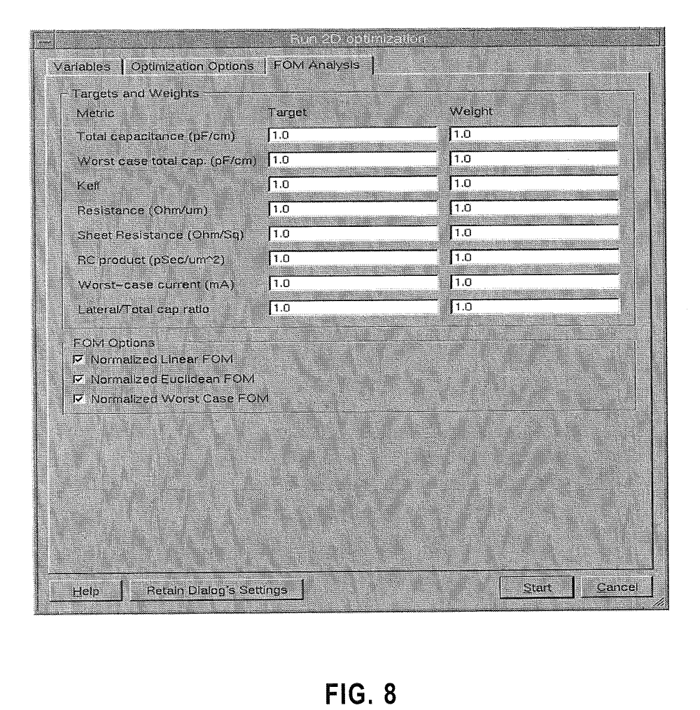

Another panel presented to the semiconductor process engineer is that of the target values of the electrical metrics as well as the priority schedule, or weight, that has been assigned to these targets; FIG. 8 shows such a panel. As mentioned, the prior art does not address the fundamental issues of layer-by-layer optimization or differences in emphasis on metric targets between different styles in digital design. A higher weight for a given target reflects the intention that more emphasis is given to its metric in the optimization process.

The exemplary embodiment combines the metric values, their targets, and their weights in a figure of merit (FOM) whose goal is to give an aggregate assessment of the goodness of the resulting process optimum. The panel allows the selections among a normalized linear FOM, a normalized Euclidean FOM, and a normalized worst-case FOM. The FOM can be any function defined on the metric values, their targets and their weights. The three FOM's provided here are merely examples of such functions.

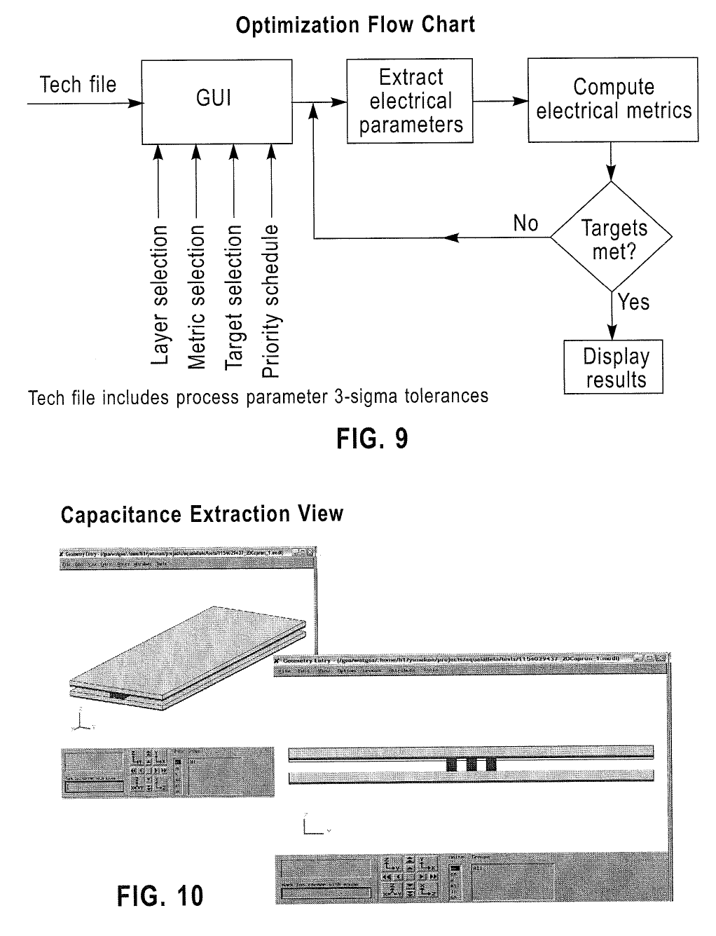

When the user clicks on the start button, the optimization process is launched. FIG. 9 represents a simplified flowchart of the optimization process. This is an iterative process that comprises three major steps.

In one step the electrical quantities needed to compute the electrical metrics are extracted. Resistance, capacitance, and inductance are among such quantities. The extraction means the transformation of technology, geometry and physical information into electrical information. It typically uses scientific computing programs for solving Maxwell's equations of electromagnetism or for solving electrical circuit equations expressed in terms of Kirchoff's laws.

Another major step is the computation of the electrical metrics. An auxiliary step is the computation of the sensitivities of these metrics with respect to small variations in the input process parameters. These sensitivities can guide the optimization in the selection of the next set of process parameters.

Once these metrics are computed the program compares their values to those of the pre-selected targets. If they are within a small neighborhood of the targets, the iterative process is stopped, and the resulting process parameters are displayed. Otherwise the three steps are repeated on a new set of process parameters.

Alternatively, the user might want to display all the computations for all the values of the process parameters. Advantageously, all these computations are launched automatically without intervention from the process engineer.

FIG. 10 is an illustration of the geometric configuration that is used for the calculation of the capacitance. It is a visual example of a centered-wire structure enclosed between two metal planes. For each set of values of process parameters, the program generates such a structure and calculates the total capacitance and coupling capacitances of the center wire using a solver, such as Maxwell's field solver.

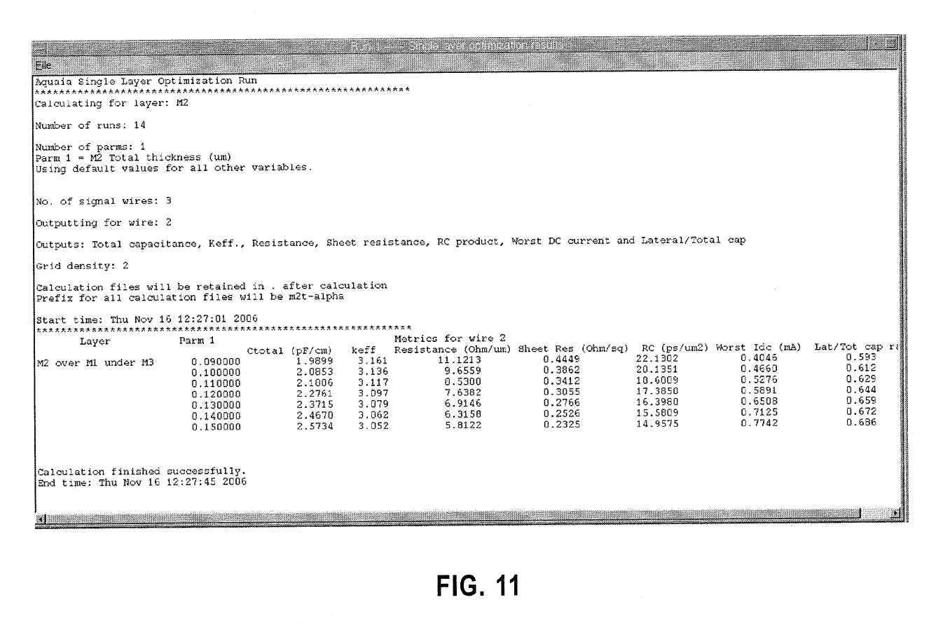

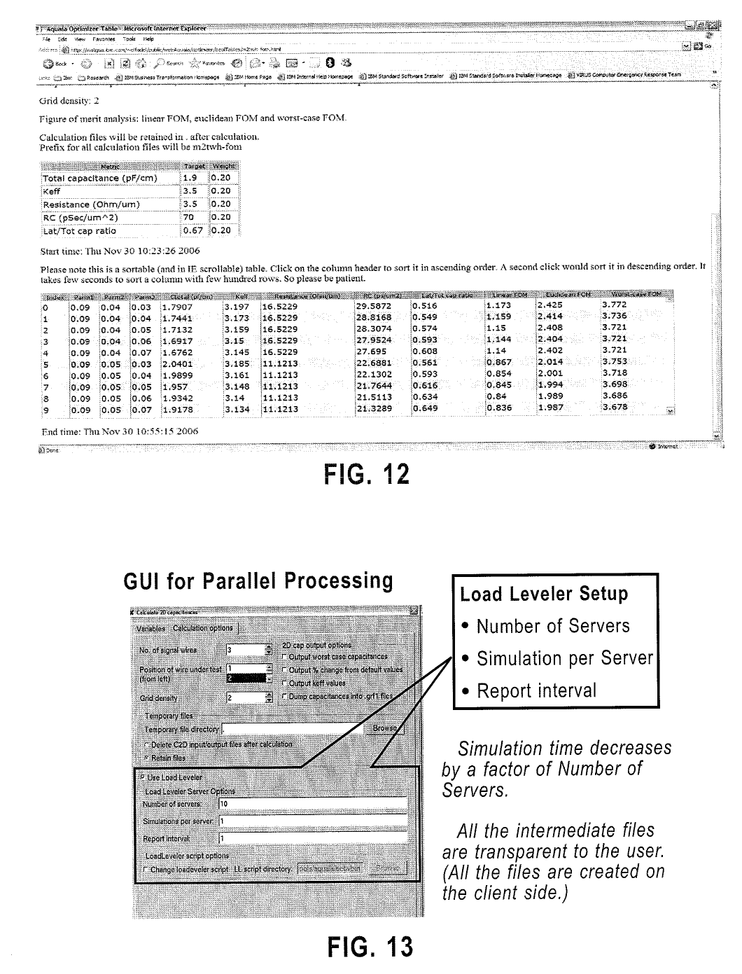

Examples of the outputs are given in FIGS. 11 and 12. FIG. 11 shows the different metrics that are computed when a single process parameter, namely, the total thickness of the M2 metal layer is varied. FIG. 12 shows both the metrics and the FOM's when three process parameters are varied. FIG. 11 is a table that is displayed using the computer native window environment (e.g., X or Windows) while the table of FIG. 12 is displayed using an available web browser. One difference of note between the two exemplary tables is that the web-publishable table is sortable in the sense that the user can click on a metric or FOM of interest and as a result, the column of corresponding values is sorted in ascending or descending order. The user can then pick those process parameters that correspond to the “top” values of the metric or the FOM.

A further embodiment includes a parallel processing capability. The optimization process may be computationally intensive and require excessive execution time when run sequentially. The evaluation of the electrical metrics for different values of the process parameters or different regions of the process parameter space can thus be run in parallel on clusters of sequential computing machines.

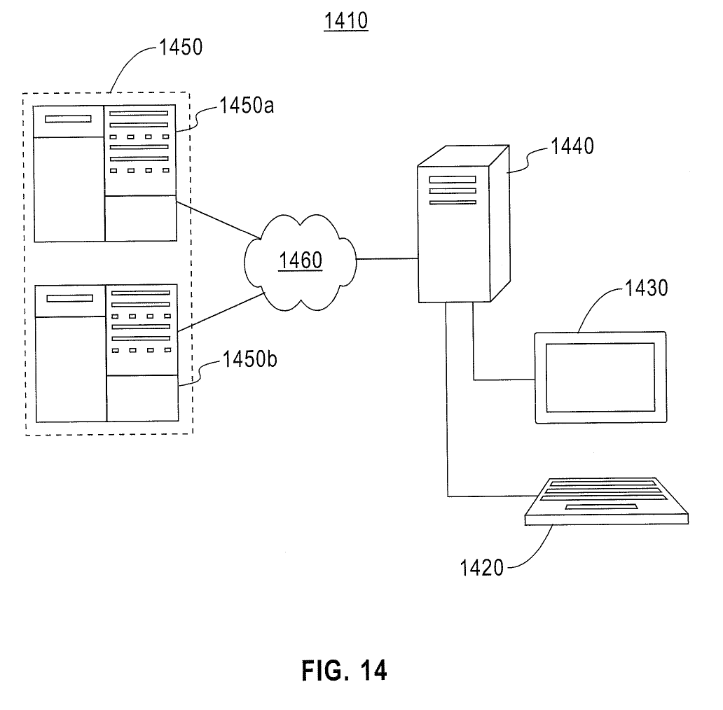

Another embodiment of this invention includes the ability to use a parallel processing feature by any semiconductor engineer not skilled in the art of parallel computing. FIG. 13 is an illustration of the graphical user interface to the parallel processing feature where the user enters the number of servers to be used and how many simulations are to be done by each server. The “Report interval” input field refers to the frequency at which reports about simulation status are to be broadcast back to the client program. Thus, a report interval of one means that such reports are to be sent at the end of each simulation.

FIG. 14 shows a system 1410 where an exemplary embodiment of the invention may be practiced. System 1410, includes a computer 1440, which contains a computer processor, memory, and input/output interfaces (not shown). Connected to the computer are user interface devices, here a display 1430 and a keyboard 1420. Here, the display 1430 is suitable for using a GUI. It should be appreciated that other interface devices may be likewise connected; examples include a mouse, and a touch sensitive screen. Computer 1440 is also connected to a cluster of sequential machines 1450 via a network 1460. The cluster of sequential machines 1450 is shown including servers 1450a andl450b, though any number of servers may be connected. The network 1460 may be a WAN, the Internet, or other network. The plurality of servers may be configured to run in parallel. The computer can gather data from the computer's memory, the cluster 1450 and/or the interface devices 1430 and 1420. The data can then be processed in the computer 1440 or by the cluster 1450. Results can be displayed via the interface devices, here display 1430.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1) A method comprising:
receiving a plurality of electrical metrics, corresponding target values, and corresponding weight factors, for each layer of a semiconductor;
receiving semiconductor process parameters, wherein at least one of the process parameters is specified as a statistical distribution;
determining at least one semiconductor process parameter that meets the plurality of electrical metrics within the corresponding target values according to their weight factors; and
providing an output of the at least one determined semiconductor process parameter.

2) The method of claim 1, further comprising generating a graphical user interface configured to facilitate the receiving of the process parameters, the electrical metrics, the target values, and the weight factors.

3) The method of claim 1, further comprising:
calculating a new set of electrical metrics from the semiconductor process parameters;
calculating sensitivity information with respect to variations in the semiconductor process parameters; and
using the calculated sensitivity information to guide the selection of the next set of process parameters.

4) The method of claim 3, wherein the electrical quantities and their sensitivities are calculated using field solvers.

5) The method of claim 1, wherein a figure of merit is used to evaluate the optimality of the process parameters.

6) The method of claim 1, wherein the determined process parameters are determined by at least one of: an exhaustive search of the process parameter space and a mathematical optimization algorithm.

7) The method of claim 6, wherein the exhaustive search procedure is performed in parallel on a cluster of sequential machines.

8) The method of claim 7, wherein the exhaustive search procedure is controlled using a graphical user interface, comprising:
an input field for the number of sequential machines;
an input field for the number of simulations per machine; and
an input field for the report interval on each machine.

9) A signal bearing medium tangibly embodying a program of machine-readable instructions executable by a digital processing apparatus to perform operations comprising:
receiving a plurality of electrical metrics, corresponding target values, and corresponding weight factors, for each layer of a semiconductor;
receiving semiconductor process parameters, wherein at least one of the process parameters is specified as a statistical distribution;
determining at least one semiconductor process parameter that meets the plurality of electrical metrics within the corresponding target values according to their weight factors; and
providing an output of the at least one determined semiconductor process parameter.

10) The program of claim 9, further comprising generating a graphical user interface configured to facilitate the receiving of the process parameters, the electrical metrics, the target values, and the weight factors.

11) The program of claim 9, further comprising:
calculating a new set of electrical metrics from the semiconductor process parameters;
calculating sensitivity information with respect to variations in the semiconductor process parameters; and
using the calculated sensitivity information to guide the selection of the next set of process parameters.

12) The program of claim 11, wherein the electrical quantities and their sensitivities are calculated using field solvers.

13) The method of claim 9, wherein a figure of merit is used to evaluate the optimality of the process parameters.

14) The program of claim 9, wherein the determined process parameters are determined by at least one of: an exhaustive search of the process parameter space and a mathematical optimization algorithm.

15) The program of claim 14, wherein the exhaustive search procedure is performed in parallel on a cluster of sequential machines.

16) The program of claim 15, wherein the exhaustive search procedure is controlled using a graphical user interface, comprising:
an input field for the number of sequential machines;
an input field for the number of simulations per machine; and
an input field for the report interval on each machine.

17) A system comprising:
a device configured to receive a plurality of electrical metrics, corresponding target values, and corresponding weight factors, for each layer of a semiconductor;
a device configured to receive semiconductor process parameters, wherein at least one of the process parameters is specified as a statistical distribution;
a device configured to generate a graphical user interface configured to facilitate the receiving of the process parameters, the electrical metrics, the target values, and the weight factors;
a device configured to determine at least one semiconductor process parameter that meets the plurality of electrical metrics within the corresponding target values according to their weight factors; and
a device configured to provide an output of the at least one determined semiconductor process parameter.

18) The system of claim 17, further comprising: a device configured to:
calculate a new set of electrical metrics from the semiconductor process parameters;
calculate sensitivity information with respect to variations in the semiconductor process parameters; and
use the calculated sensitivity information to guide the selection of the next set of process parameters.

19) The system of claim 18, wherein the determined process parameters are determined by an exhaustive search procedure which is performed in parallel on a cluster of sequential machines.

20) The system of claim 19, wherein the exhaustive search procedure is controlled using a graphical user interface, comprising:
an input field for the number of sequential machines;
an input field for the number of simulations per machine; and
an input field for the report interval on each machine.
